(19) United States
(12) Patent Application Publication
(10) Pub. No.: US 2008/0149186 A1
(43) Pub. Date: Jun. 26, 2008

(54) Method and apparatus for emission management

(76) Inventor: Ricky L. Martin, Baytown, TX (US)

Correspondence Address: LAW OFFICE OF DAVID MCEWING, P.O. BOX 231324, HOUSTON, TX, 77023, US

(21) Appl. No.: 11/703,469

(22) Filed: Feb. 7, 2007

Related U.S. Application Data
(60) Provisional application No. 60/876,238, filed on Dec. 21, 2006.

(51) Int. Cl. F15B 5/00

(52) U.S. Cl. 137/85

(57) ABSTRACT

A combination pneumatic and electro-pneumatic gas valve positioning system comprising a pneumatic positioner and an electro-pneumatic positioner in parallel. The apparatus also includes at least one solenoid to control gas flow between the electro-pneumatic positioner and the pneumatic positioner.

### RELATED PROCEEDINGS

This application claim the benefit of and priority to provisional application No. 60/876,238, entitled “Method and Apparatus for Emission Management” file Dec. 21, 2006, and which is incorporated herein by reference.

### TECHNICAL FIELD

The invention pertains to a method of control of gas emissions from a gas valve.

### RELATED ART

Pneumatic and electro-pneumatic gas valve controllers are known in the industry.

### SUMMARY OF INVENTION

A combination pneumatic and electro-pneumatic gas valve positioning system comprising a pneumatic positioner and an electro-pneumatic positioner configured in parallel wherein the pneumatic positioner operates when the electro-pneumatic positioner is not operating.

### SUMMARY OF DRAWINGS

The accompanying drawings, which are incorporated in and constitute a part of the specification, illustrate embodiments of the invention. These drawings, together with the general description of the invention given above and the detailed description of the embodiments, i.e., examples, given below, serve to explain the principles of the invention.

FIG. 1 is a schematic drawing of one embodiment of the invention.

FIG. 2 is a schematic drawing of another embodiment of the invention showing the parallel configuration of the pneumatic control line and the electro-pneumatic control line.

FIG. 3 illustrates the controls of the Fisher 3582 pneumatic positioner

FIG. 4 illustrates the electrical components (Type 3582i Positioner) that may be installed on the Fisher 3582 positioner.

FIG. 5 illustrates the position of a pneumatic positioner and separate electro-pneumatic positioner in relation to the valve component.

FIG. 6 illustrates a solenoid and 3 way valve as one component of the invention.

### DETAILED DESCRIPTION OF INVENTION

While this apparatus disclosed herein is susceptible of embodiments in many different forms, there is shown in the drawings and will herein be described in detail embodiments with the understanding that the present disclosure is to be considered as an exemplification of the principles of the disclosure and these examples are not intended to limit its broad aspect. The above general description and the following detailed description are merely illustrative and additional modes, advantages and particulars will be readily suggested to those skilled in the art without departing from the spirit and scope,

Pneumatic valve positioning devices utilized in oil and gas production and transportation are a major source of fugitive methane gas emissions. It is estimated that operation of pneumatic positioning devices are responsible for approximately 40 percent of the methane losses in oil and gas production.

In one application, pneumatic devices are utilized as the control or positioning mechanism (pneumatic positioners) for gas values, including but not limited to valves incorporated into gas pipe lines. A stream of gas may be diverted to the pneumatic control device and the pressure of the gas is utilized to move the valve or to maintain the valve in a fixed position. In one example, a natural gas pipeline is tapped and regulated to be utilized as a control or signaling device and power supply. The pipeline contains a gas under pressure. The pneumatic positioner experiences continuing gas pressure. This may result in gas being continuously emitted from the device. The quantity of the gas emissions may increase when the pressure at the control device is altered to move the valve position. Emissions of the gas (e.g., methane or natural gas) are also termed “bleeding”.

As indicated, gas emission will be experienced with a change in the valve position. This may be the result of bleeding or venting of a quantity of gas from the pneumatic positioner.

In one embodiment, the invention discloses the installation and operation of an electro-pneumatic positioner or valve controller to control a gas valve where the existing pneumatic positioner becomes a backup controller. The pneumatic positioner is kept in place and serves as a backup controller in the event of a disruption of electrical power. The selected electro-pneumatic positioner may be selected for its low bleed or gas emissions rate.

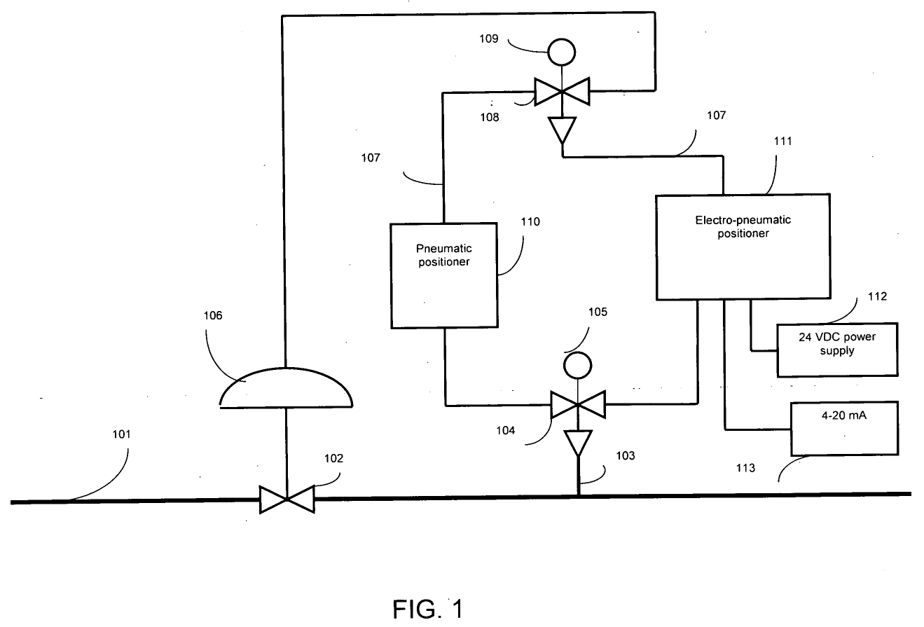

FIG. 1 represents a schematic of this described example of the invention. The pre-existing pneumatic and newly installed electro-pneumatic positioners are arranged in parallel to the other.

In one example of the invention, an electro-pneumatic controller 111 is utilized in conjunction with one or more solenoids 105, 109. Gas pressure is supplied to the electro-pneumatic positioner by operation of a first solenoid 105. The second solenoid 109 prevents the transmission of the gas to the backup pneumatic controller 110 and facilitates the operation of the electrical positioner in controlling the position of the gas valve 102. In this example, a loss of power in the system or within the loop will cause the first solenoid 105 to close access of gas to the electro-pneumatic positioner 111 and shift the gas to the backup pneumatic controller 110. The second solenoid 109 switches and blocks the transmission of gas from the backup pneumatic controller to the electro-pneumatic positioner.

FIG. 1 also illustrates utilization of a 3-way valve 104 controlled by a solenoid 105. The valve controls a supply of gas 103 from the natural gas supply line 101. A second 3-way 108 valve is controlled by a solenoid 109. This valve also controls the flow of gas (gas outlet) 107 between the pneumatic positioner and the electro-pneumatic positioner. For example, in the event of power disruption, the solenoid 105 will cause the valve 104 to shift the gas supply from the electro-pneumatic positioner to the pneumatic positioner.

Also illustrated in FIG. 1 is the 24 volt DC power supply 112 used for the electro-pneumatic positioner and the 4-20 mA control signal 113.

In another example, the electro-pneumatic valve control devices may be independent of the pneumatic positioner and can decrease the quantity of fugitive gas emissions. The electro-pneumatic control device may independently move the valve stem or stem connector. In one example, a pneumatic control device remains as a backup to the electro-pneumatic device. This permits the continued control of the valve in the event of electrical power disruption, e.g. failure, (for example 24 volt DC) or loss of the electrical control signal (for example 4-20 mA). The pneumatic controller and the electro-pneumatic controller may have separate attachment components to the valve stem.

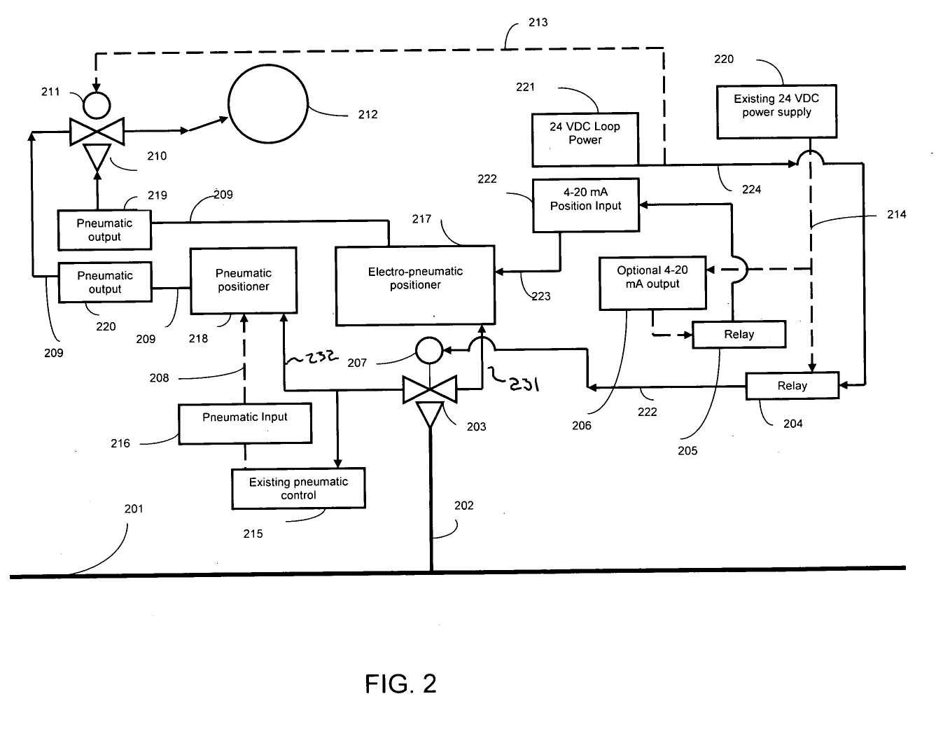

FIG. 2 illustrates schematic view of a second embodiment. Illustrated is the three way valve 203 and solenoid 207. One gas line 231, controlled by the 3 way valve, is in communication with the electro-pneumatic positioner.

Another gas line 232 connected to the 3 way valve is in communication with the existing pneumatic control and the pneumatic positioner.

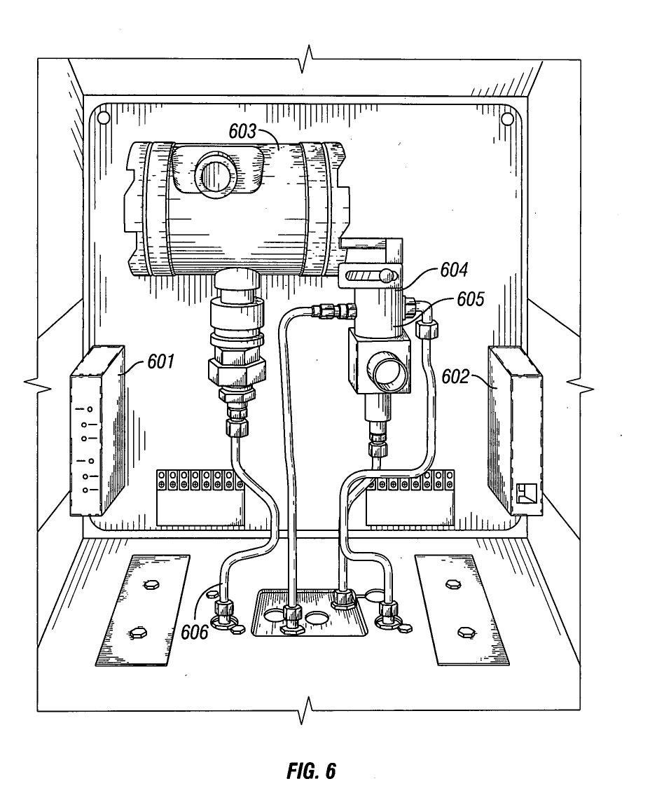

FIG. 2 also illustrates an “optional” 4-20 mA output 206. This is marked optional since in some applications, a 4-20 mA control signal may already be present at the valve controls. This device is also illustrated in FIG. 6 as a pressure transmitter controller. The component transforms the gas pressure into a 4-20 mA signal.

FIG. 2 also illustrates two relays 204, 205. These devices are also illustrated in FIG. 6 wherein the components are labeled and 601 and 602. In the configuration illustrated, in FIG. 2, switch 2 204 acts as a current to voltage converter. In the embodiment illustrated, switch 1 205 serves as a splitter of the 4-20 mA signal.

FIG. 2 illustrates the electro-pneumatic positioner 217 and the pneumatic positioner 218 in parallel. Parallel electrical circuits are one basic way of wiring components. A parallel circuit is one that requires more than one path for current flow in order to reach all of the circuit elements. The names describe the method of attaching components, that is next to each other. The respective lines of communicate with separate pneumatic outputs 219, 220 and converging on a 3 way valve 210 controlled by a solenoid 211 and then to the valve actuator. Also illustrated is the power input 213 running to the solenoid.

Also illustrated is the existing 24 VDC power supply 220. Also illustrated is a 24 VDC Loop Power 221. There is a 4-20 mA Position Input 222 in electrical communication 223 with the electro-pneumatic positioner. The relay 204 is in electrical communication 214 with the existing 24 VDC power supply 220

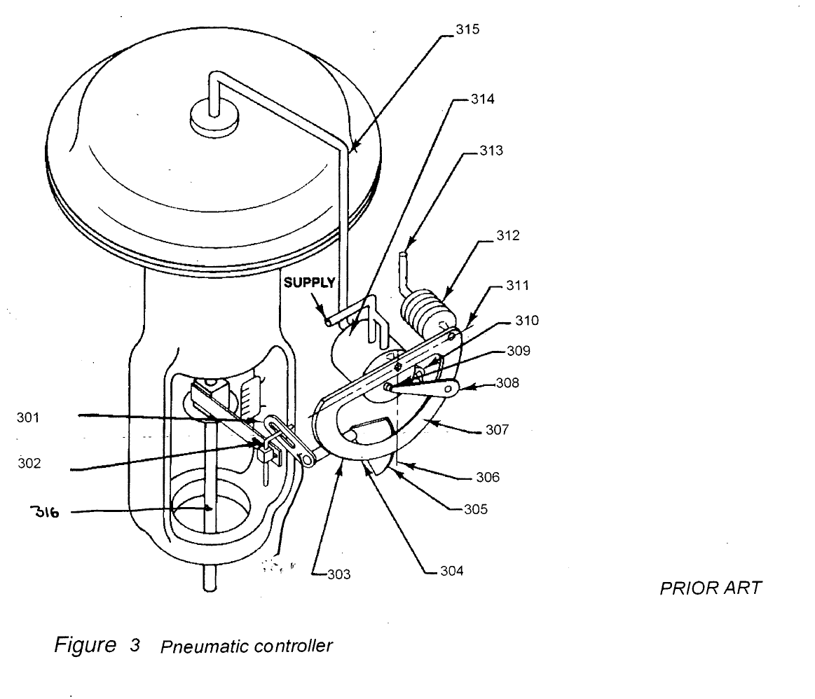

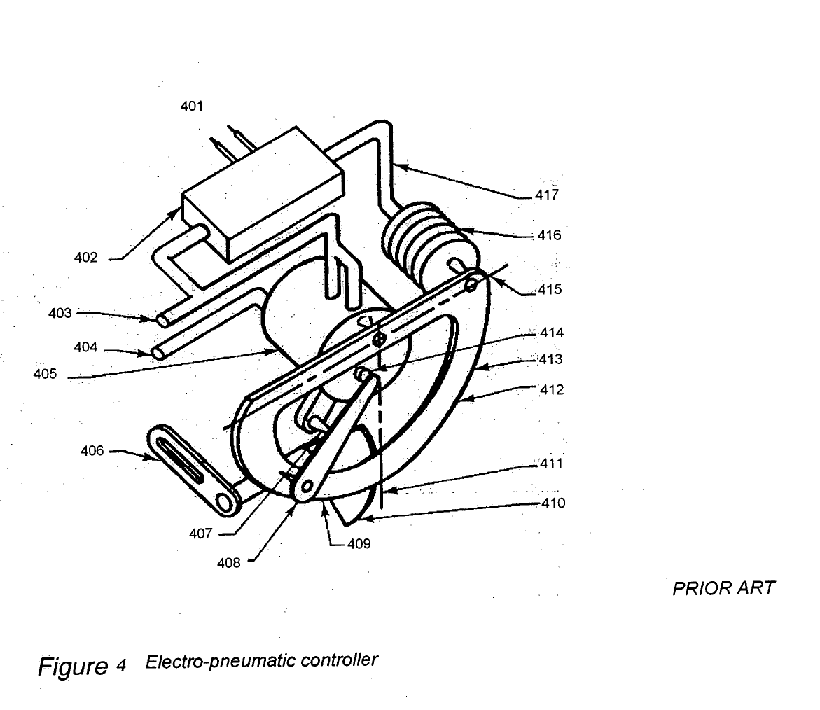

A prior art example of an electro-pneumatic control device is illustrated in the combination of FIGS. 3 and 4. FIG. 3 illustrates a 3582 Fisher pneumatic controlled valve. FIG. 4 illustrates the unit converted to an electro-pneumatic control. The Fisher 3582i electro-pneumatic component (FIG. 4) adaptable to the 3582 pneumatic positioner provides a pneumatic signal to the nozzle/flapper controls of the Fisher 3582. Note that the conversion does not decrease the quantity of the gas emissions. In one example, the pneumatic control device may be Pneumatic Positioner. This does not decrease the quantity of gas emissions.

Turning to FIG. 3, illustrated is the rotary shaft arm 301 and travel pin 302 connected to the valve stem 316. Also illustrated is the flapper assembly 308 operating in conjunction with the beam 303, the cam 305 and the nozzle 309. The beam comprises a directing acting quadrant 307 and a reverse acting quadrant 304. There is also a feedback axis 311. Also illustrated is a pivot 310.

Also illustrated in FIG. 3 is a relay 314, an instrument input 313 and bellow 312. The output to actuator is also illustrated 315 in communication with the relay.

FIG. 4 illustrates electro-pneumatic components that may be substituted for the pneumatic components discussed above. The conversion does not result in two separate controllers in communication with the valve stem. There remains a single connection to the valve stem. Illustrated is the rotary arm shaft 406, the flapper assembly 408, the pivot 407 and the nozzle 414. Also illustrated is the beam 413 comprising an input axis 411, the reverse acting quadrant 409, the direct acting quadrant 412 and the feedback axis.

In regard to the electro-pneumatic controls, components include a 4-20 milliampere input signal 401, a converter 402, supply line 403 and output to actuator 404 (in communication with a relay 405).

It will be appreciated that the electrical components illustrated in FIG. 4 merely supply a 4-20 mA signal without change in the gas utilization control mechanism. The quantity of gas emissions from the Fisher 3582 pneumatic positioner is not decreased by addition of the Fisher 3582i component. This is in contrast to the present invention wherein an electro-pneumatic positioner is installed and decreases gas emissions. This is accomplished by selected electron-pneumatic units.

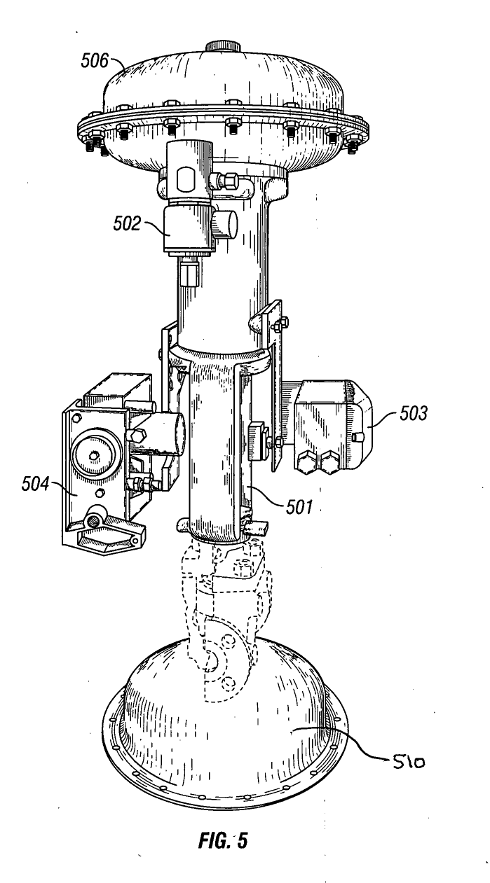

FIG. 5 illustrates the valve apparatus comprising a base 510 and actuator component 506. Also illustrated is the pneumatic control 504 connected to the valve stem (not shown). The pneumatic control may also be connected to a solenoid 502. Also illustrated is the connection components of the electro-pneumatic 503 connected to the valve stem 501.

FIG. 6 illustrates additional components. These components are also represented in the schematic drawings of FIGS. 1 and 2. Illustrated is the pressure transducer controller 603 converting a 4-20 mA signal through switch 602. The wire from the controller to the instrumentation is not shown. The pressurized gas line is illustrated 605. Also illustrated is the solenoid 604 and 3 way valve 605.

FIG. 6 illustrates 601 switch 1 serves as a splitter of the 4-20 mA signal.

In another embodiment of the invention, a relay (e.g., Acromag current to voltage converter 602 ) is utilized to convert the system from electro-pneumatic to pneumatic control upon loss of the 4-20 mA signal and to function as a current to voltage converter. (See FIG. 2 and the relay in communication with Solenoid 207.

The electro-pneumatic positioner 503 of the present invention may be an ABB TZID-C Hart Communicating Positioner that independently controls the position of the value. Information on the ABB positioner is available at www.ABB.com or ABB, Inc., Warminster, Pa. It will be appreciated that the electro-pneumatic controls connected to the valve stem are separate from the controls of the pneumatic positioner. It will be appreciated that the pneumatic positioner may be maintained in operational position to control the valve actuator in the event of disruption of the electrical power.

In one example, the electrical power source may be 24 volt DC. In one example, the electrical control signal is 4-20 mA. Other examples of control signals include fieldbus and Profibus. The electro-pneumatic control device may include a pressure transmitter controller (603 in FIG. 6) where gas pressure is converted to an electrical signal such as 4-20 mA. This controller may include proportional-integral-derivative (PID) controller functions.

Other standards for electrical transmission for industrial instrumentation and communication are included within the scope of the invention, including but not limited to digital forms of communication.

One object of the invention is to eliminate most fugitive gas emissions associated with the use of existing and installed Fisher or other major suppliers of pneumatic valve controls, while still allowing for the retention of this existing pneumatic control as backup. The electro-pneumatic substantially reduce the emission of gas. In one embodiment of the present invention, the existing pneumatic system remains in place as a backup to an installed electro-pneumatic positioner.

Another object is to utilize Hart communicating system (compatible with the Hart Protocol) and including a low bleed (low emission) valve positioner. For example, the apparatus may utilize a 0.015 standard cubic feet per minute (scfm) rated bleeding device in contrast to the common Fisher pneumatic control device with a rated bleed of 0.5 scfm.

The Hart Communications Protocol is a leading communication technology used with smart process instrumentation. Hart is field proven, easy to use and provides highly capable two-way digital communication simultaneously with the 4-20 mA analog signaling used by traditional instrumentation equipment.

The invention can include a PID controller/transmitter that is field selectable within one unit and associated components to achieve the electro-pneumatic system. A PID controller is a feedback loop component wherein the controller takes a measured value from a process or other apparatus and compares it with a reference set-point value.

Installation of the electro-pneumatic positioner Will significantly reduce the fugitive emissions from the value positioner components. In addition, electrical positioner will be automatically shutdown and the backup pneumatic system is activated in the event safeguards are activated. These safe guards include (i) loss, i.e., disruption, of 24 VDC loop power, (ii) disruption of 24 VDC system power, or (iii) disruption of 4-20 mA control signal. The gas valve remains controlled at all times.

In one example, emissions were reduced by installation of the electronic positioner. An estimated bleed loss per day was achieved based upon 100% bleed of 21.6 scfd (0.015 scfm) using an ABB TZIDC positioner. In one example, the electro-pneumatic positioner connects directly to the valve actuator in contrast to the connecting to the existing pneumatic positioner.

In contrast to the 21.6 scfd loss discussed above, a 3582 Fisher Pneumatic Positioner has an estimated bleed loss (emission of gas) of 336 scfd per day.

As indicated above, most gas valve positioning apparatus utilize pneumatic controlled devices. The devices are powered by gas, e.g., methane or natural gas, diverted from the main gas line. This results in undesired emissions of the gas into the atmosphere.

In order to decrease these fugitive emissions of gas, electro-pneumatic positioners may be installed. However, to maintain the ability to control the gas valve in the event of electrical power failure, e.g., loss of control signal, loss of loop power, or loss of power, the existing pneumatic control system is retained. As explained above, valves controlled by solenoids may switch the gas supply from the electro-pneumatic positioner to the pneumatic positioner.

In addition to the ABB TZID-C Hart Communicating Positioner, other suitable components include but are not limited to a Siemans PS2, a Siemans PS2 modified by DynaFlo, and components from Valve Accessories.

In another embodiment of the invention, a relay (e.g., Acromag current to voltage converter) is utilized to convert the system from electro-pneumatic to pneumatic control upon loss of the 4-20 mA signal and to function as a current to voltage converter. (See FIG. 2 and the relay 204 in communication with the Solenoid 207. This current to voltage converter is also shown in FIG. 6, labeled Switch 602.)

While specific embodiments have been illustrated and described, numerous modifications are possible without departing from the spirit of the invention, and the scope of protection is only limited by the scope of the accompanying claims.

1. A combination pneumatic and electro-pneumatic gas valve positioning system comprising:
a) pneumatic positioner; and
b) an electro-pneumatic positioner in parallel to the pneumatic positioner.

2. The system of claim 1 further comprising a pneumatic positioner attached to the valve stem and the electro-pneumatic position is separately attached to the valve stem.

3. The system of claim 1 further comprising at least one solenoid to control gas flow between the electro-pneumatic positioner and the pneumatic positioner.

4. The system of claim 1 further comprising at least one valve to control the flow of gas between the electro-pneumatic positioner and the pneumatic positioner.

5. A valve positioning system comprising an electro-pneumatic positioner and a pneumatic positioner wherein the pneumatic positioner controls the valve if the electrical power is disrupted.

6. The system of claim 5 further comprising
a) a pressure transmitter converting gas pressure to an electrical signal;
c) a solenoid; and
d) a three way valve.

7. The system of claim 6 further comprising a relay and a current to voltage converter.

8. A combination pneumatic and electro-pneumatic gas valve positioning system comprising:
a) pneumatic positioner;
b) an electro-pneumatic positioner in parallel to the pneumatic positioner; and
c) each positioner may be operated independently

9. The combination of claim 8 further comprising the pneumatic positioner and the electromagnetic position each having separate attachments to the valve stem.
